(19) United States
(12) Patent Application Publication
(10) Pub. No.: US 2016/0088530 A1
(43) Pub. Date: Mar. 24, 2016

(54) MOBILE COMMUNICATION SYSTEM

(71) Applicant: NTT DOCOMO, INC., Tokyo (JP)

(72) Inventors: Tooru Uchino, Tokyo (JP); Hideaki Takahashi, Tokyo (JP); Satoshi Nagata, Tokyo (JP); Wuri Andarmawanti Hapsari, Tokyo (JP); Kazuki Takeda, Tokyo (JP)

(73) Assignee: NTT DOCOMO, INC., Tokyo (JP)

(21) Appl. No.: 14/888,826

(22) PCT Filed: May 9, 2014
(86) PCT No.: PCT/JP2014/062468

§ 371 Date: Nov. 3, 2015

(30) Foreign Application Priority Data
May 9, 2013 (JP) 2013-099364

(51) Int. Cl. H04W 36/00; H04W 36/08; H04W 72/12

(52) U.S. Cl. CPC H04W 36/0055; H04W 72/1289; H04W 36/08

(57) ABSTRACT

Implementation of “RRC diversity” in a handover procedure between cells under different radio base stations (eNB), while considering conditions in a physical layer, is disclosed. In a mobile communication system including a radio base station (eNB #1) managing a cell (#1) and a radio base station (eNB #10) managing a cell (#10), the radio base station (eNB #1) and the radio base station (eNB #10) are configured to transmit “HO command” to a mobile station (UE) connected to the cell (#1), respectively, when a handover to the radio base station (eNB #10) is performed. The radio base station (eNB #1) and the radio base station (eNB #10) are configured to switch a subframe, to which PDCCH for transmitting scheduling information concerning the “HO command” can be allocated, in a time-division manner between the radio base station (eNB #1) and the radio base station (eNB #10).

### TECHNICAL FIELD

The present invention relates to a mobile communication system.

### BACKGROUND ART

In LTE (Long Term Evolution), when a mobile station UE in “RRC Connected state” moves across a cell boundary, a handover procedure is to take place in order to cause the mobile station UE to perform communication always by using an appropriate cell.

However, when the handover procedure takes place between cells using the same frequency, there is a concern that the mobile station UE cannot receive “HO command” from a handover source cell due to interference from a neighboring cell, and the handover procedure ends up in failure (see FIG. 6(a)).

Accordingly, as shown in FIG. 6(b), there has been proposed a control method (RRC diversity) configured to transmit the “HO command” not only from the handover source cell but also from a handover destination cell in order to improve a probability of reception of the “HO command” by the mobile station UE, and thus to suppress a failure in the handover procedure (see Non-patent Document 1).

Here, the “RRC diversity” can be implemented by CoMP transmission-reception (Coordinated Multi-Point transmission-reception) on a downlink.

Note that the CoMP transmission-reception on the downlink is a technique for improving throughput on the downlink by transmitting either the same or different data from multiple (a plurality of) TPs (Transmission Points) to the mobile station UE.

### PRIOR ART DOCUMENT

### Non-Patent Document

Non-patent document 1: 3GPP Written Contributions R2-131211

### SUMMARY OF THE INVENTION

At present, the CoMP transmission-reception on the downlink can be carried out only in the cells under the same radio base station eNB.

Accordingly, there is a problem that the “RRC diversity” cannot be implemented in a handover procedure between cells under different radio base stations eNB as shown in FIG. 7.

Moreover, as shown in FIG. 8, a physical layer needs to be adjusted such that contention of resources for PDCCH (Physical Downlink Control Channel) for notification of scheduling information (DCI: Downlink Control Information) concerning “HO command” may not occur between a handover source radio base station S-eNB and a handover destination radio base station T-eNB.

However, the conventional LTE method does not consider the above-mentioned conditions in the physical layer in implementing the “RRC diversity,” and therefore has a problem that it is not possible to implement the “RRC diversity” in the handover procedure between the cells under different radio base stations eNB.

The present invention has been made in view of the aforementioned problem. An object of the present invention is to provide a mobile communication system which is capable of implementing “RRC diversity” in a handover procedure between cells under different radio base stations eNB, while considering conditions in a physical layer.

A first feature of the present invention is summarized as a mobile communication system including: a first radio base station configured to manage a first cell; and a second radio base station configured to manage a second cell. Here, the first radio base station and the second radio base station are configured to transmit a handover instruction signal to a mobile station connected to the first cell, in the first cell and the second cell, respectively, when a handover of the mobile station to the second cell is performed, and the first radio base station and the second radio base station are configured to switch a subframe in a time-division manner between the first radio base station and the second radio base station, the subframe being a subframe to which a physical downlink control channel to transmit scheduling information concerning the handover instruction signal is allocatable.

A second feature of the present invention is summarized as a mobile communication system including: a first radio base station configured to manage a first cell; and a second radio base station configured to manage a second cell. Here, the first radio base station and the second radio base station are configured to transmit a handover instruction signal to a mobile station connected to the first cell, in the first cell and the second cell, respectively, when a handover of the mobile station to the second cell is performed, the first radio base station is configured to transmit scheduling information concerning the handover instruction signal through a physical downlink control channel, and the second radio base station is configured to transmit scheduling information concerning the handover instruction signal through an enhanced physical downlink control channel.

### BRIEF DESCRIPTION OF THE DRAWINGS

FIG. 1 is a view for explaining an overall configuration of a mobile communication system according to an embodiment of the present invention.

FIG. 2 is a functional block diagram of a radio base station eNB #1/eNB #10 according to the embodiment of the present invention.

FIG. 3 is a diagram for explaining an operation of the mobile communication system according to the embodiment of the present invention.

FIG. 4 is a diagram for explaining an operation of a mobile communication system according to a first modified example of the present invention.

FIG. 5 is a diagram showing an example of a downlink subframe structure in the mobile communication system according to the first modified example of the present invention.

FIG. 6 is a view for explaining the related art.

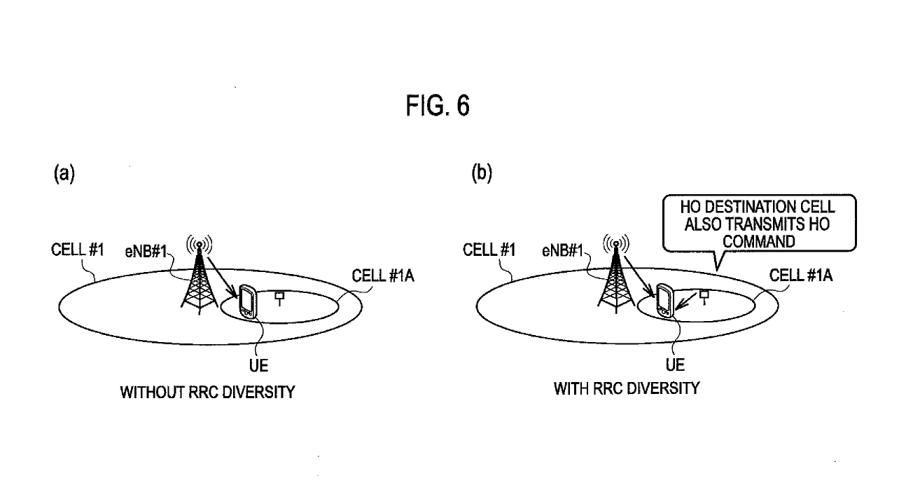

FIG. 7 is a view for explaining the related art.

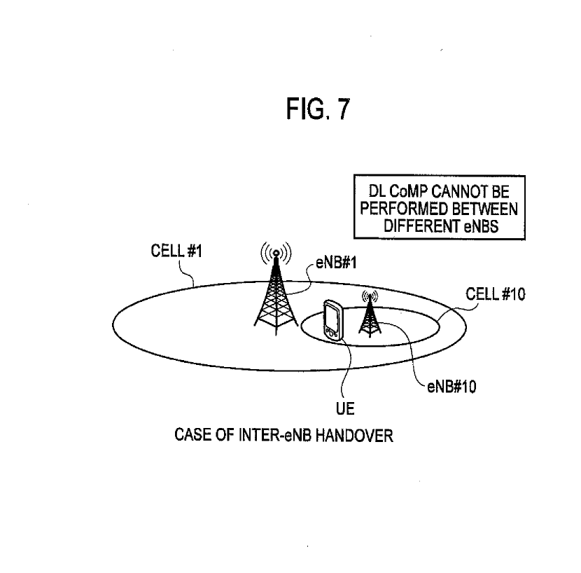

FIG. 8 is a view for explaining the related art.

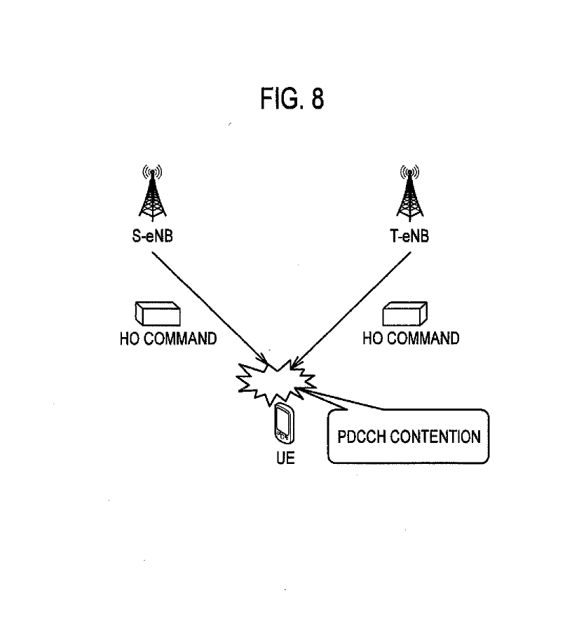

### DETAILED DESCRIPTION

### (Mobile Communication System According to Embodiment of Present Invention)

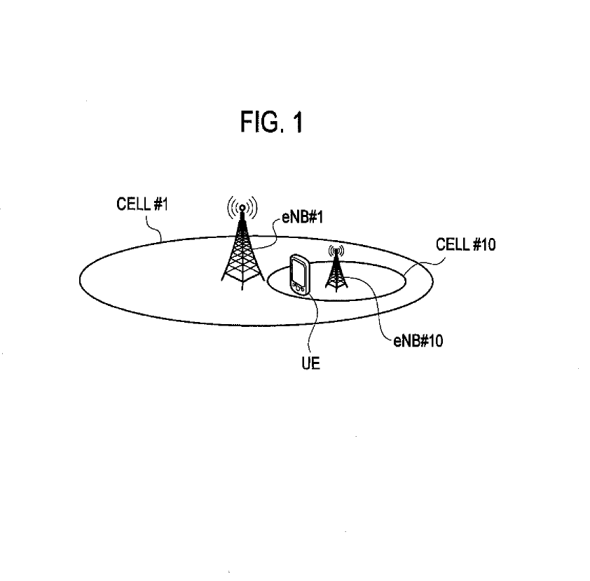

A mobile communication system according to an embodiment of the present invention will be described with reference to FIG. 1 to FIG. 3.

As shown in FIG. 1, a mobile communication system of this embodiment includes a radio base station eNB #1 which manages a cell #1, and a radio base station eNB #10 which manages a cell #10.

An area covered by the cell #1 and an area covered by the cell #10 are designed to at least partially overlap each other geographically. Here, the cell #1 and the cell #10 are cells using the same frequency.

For example, the cell #1 may be a macro cell while the cell #10 may be a small cell such as a phantom cell.

Meanwhile, the mobile communication system of this embodiment is configured to be capable of carrying out CoMP on a downlink between the cell #1 under the radio base station eNB #1 and the cell #10 under the radio base station eNB #10.

Note that this embodiment will be described on the assumption that a mobile station UE connected to the cell #1 is to be handed over to the cell #10.

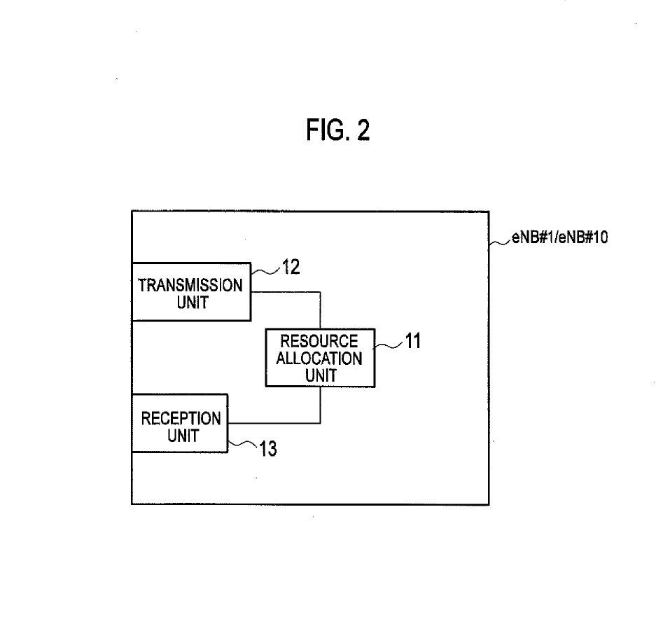

As shown in FIG. 2, the radio base station eNB of this embodiment, namely, each of the radio base stations eNB #1 and eNB #10 of this embodiment includes a resource allocation unit 11, a transmission unit 12, and a reception unit 13.

The resource allocation unit 11 of the radio base station eNB #1 is configured to manage resources in the cell #1, including PDSCH (Physical Downlink Shared Channel), PDCCH, PUSCH (Physical Uplink Shared Channel), PUCCH (Physical Uplink Control Channel), and the like.

Meanwhile, the resource allocation unit 11 of the radio base station eNB #10 is configured to manage resources in the cell #10, including PDSCH, PDCCH, PUSCH, PUCCH, and the like.

The reception unit 13 of the radio base station eNB #1 is configured to receive various signals from the mobile station UE and the radio base station eNB #10, and the transmission unit 12 of the radio base station eNB #1 is configured to transmit various signals to the mobile station UE and the radio base station eNB #10.

Meanwhile, the reception unit 13 of the radio base station eNB #10 is configured to receive various signals from the mobile station UE and the radio base station eNB #1, and the transmission unit 12 of the radio base station eNB #10 is configured to transmit various signals to the mobile station UE and the radio base station eNB #1.

Specifically, when the mobile station UN connected to the cell #1 performs a handover to the cell #10, the transmission unit 12 of the radio base station eNB #1 and the transmission unit 12 of the radio base station eNB #10 are configured to transmit “HO command” to the mobile station UE in the cell #1 and the cell #10, respectively.

In this case, the resource allocation unit 11 of the radio base station eNB #1 and the resource allocation unit 11 of the radio base station eNB #10 are configured to allocate the PDCCH for notification of scheduling information (DCI) concerning the “HO command” to the mobile station UN.

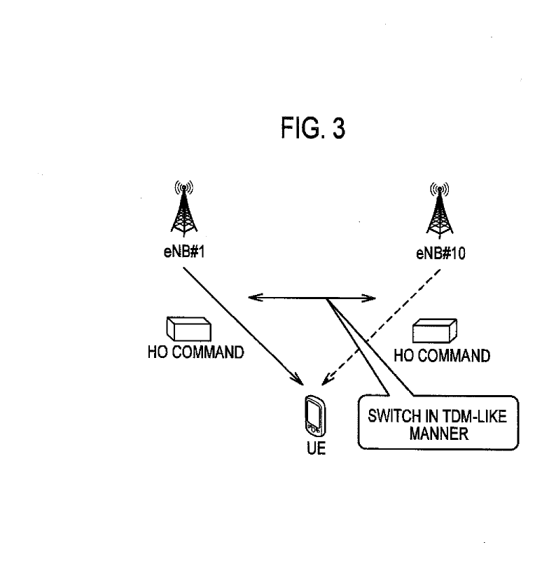

Here, as shown in FIG. 3, a subframe to which the PDCCH for notification of the scheduling information concerning the “HO command” can be allocated is configured to be switched in a time-division manner between the resource allocation unit 11 of the radio base station eNB #1 and the resource allocation unit 11 of the radio base station eNB #10.

Note that the scheduling information for switching the PDCCH by time division between the radio base station eNB #1 and the radio base station eNB #10 may be configured to be determined between the radio base station eNB #1 and the radio base station eNB #10 in CoMP transmission-reception establishment processing, for example.

For instance, by using “CoMP preparation” and “CoMP ACK,” the radio base station eNB #1 and the radio base station eNB #10 may be adjusted not to transmit the “HO command” simultaneously by using the same resources for the PDCCH.

### (First Modified Example)

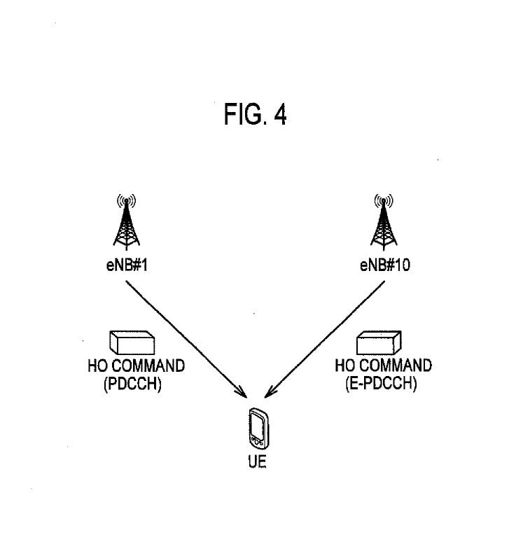

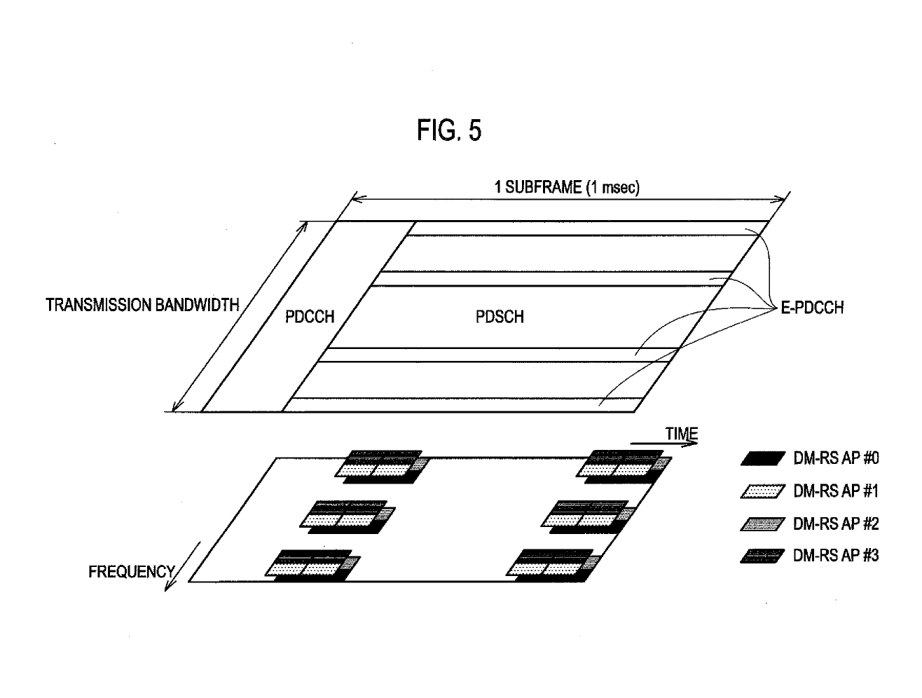

A mobile communication system according to a first modified example of the present invention will be described below with reference to FIG. 4 and FIG. 5 while focusing on different features from those of the mobile communication system according to the above-mentioned embodiment.

In the mobile communication system according to the first modified example as well, when the mobile station UE connected to the cell #1 performs a handover to the cell #10, the transmission unit 12 of the radio base station eNB #1 and the transmission unit 12 of the radio base station eNB #10 are configured to transmit “HO command” to the mobile station UE in the cell #1 and the cell #10, respectively.

In this case, as shown in FIG. 4, the radio base station eNB #1 is configured to notify of the scheduling information concerning the “HO command” through the PDCCH. The radio base station eNB #10 is configured to notify of the scheduling information concerning the “HO command” through an E-PDCCH (Enhanced-PDCCH).

FIG. 5 shows an example of a configuration of a downlink subframe. As shown in FIG. 5, resources for the PDCCH and resources for the H-PDCCH are arranged not to cause contention in each subframe.

Note that the above-mentioned scheduling information may be determined between the radio base station eNB #1 and the radio base station eNB #10 in the CoMP transmission-reception establishment processing, for example.

For instance, by using the “CoMP preparation” and the “CoMP ACK, ” the radio base station eNB #1 and the radio base station eNB #10 may be adjusted not to transmit the “HO command” by using the same resources.

The features of the present embodiment may also be expressed as follows.

A first feature of the present embodiment is summarized as a mobile communication system including: a radio base station eNB#1 (first radio base station) configured to manage a cell #1 (first cell); and a radio base station eNB#10 (second radio base station) configured to manage a cell #10 (second cell). Here, the radio base station eNB#1 and the radio base station eNB#10 are configured to transmit “HO command (handover instruction signal)” to a mobile station UE connected to the cell #1, in the cell #1 and the cell #10, respectively, when a handover of the mobile station UE to the cell #10 is performed, and the radio base station eNB#1 and the radio base station eNB#10 are configured to switch a subframe in a time-division manner between the radio base station eNB#1 and the radio base station eNB#10, the subframe being a subframe to which PDCCH (physical downlink control channel) to transmit scheduling information concerning the “HO command” is allocatable.

According to the above-described aspect, the subframe to which the PDCCH for notification of the scheduling information concerning the “HO command” can be allocated is switched in the time-division manner between the radio base station eNB #1 and the radio base station eNB #10. Thus, it is possible to achieve adjustment such that resource contention will not occur for the PDCCH for the notification of the scheduling information.

A second feature of the present embodiment is summarized as a mobile communication system including: a radio base station eNB#1 (first radio base station) configured to manage a cell #1 (first cell); and a radio base station eNB#10 (second radio base station) configured to manage a cell #10 (second cell). Here, the radio base station eNB#1 and the radio base station eNB#10 are configured to transmit “HO command” to a mobile station UE connected td the cell #1, in the cell #1 and the cell #10, respectively, when a handover of the mobile station UE to the cell #10 is performed, the radio base station eNB#1 is configured to transmit scheduling information concerning the “HO command” through POOCH (physical downlink control channel), and the radio base station eNB#10 is configured to transmit scheduling information concerning the “HO command” through an E-PDCCH (enhanced physical downlink control channel).

According to the above-described aspect, the radio base station eNB #1 is configured to notify of the scheduling information concerning the “HO command” through the PDCCH, while the radio base station eNB #10 is configured to notify of the scheduling information concerning the “HO command” through the E-PDCCH. Thus, it is possible to achieve the adjustment such that resource contention will not occur for the notification of the scheduling information.

In the first feature of the present embodiment, the scheduling information for switching the PDCCH in the time-division manner may be determined between the radio base station eNB#1 and the radio base station eNB#10 in CoMP transmission-reception (coordinated multi-point transmission-reception) establishment processing.

According to the above-described feature, it is possible to achieve the adjustment in such a way not to transmit the “HO command” simultaneously by using the same resources for the PDCCH.

It should be noted that the foregoing operations of the mobile station OE and radio base stations eNB#1/eNB#10 may be implemented by hardware, maybe implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE and radio base stations eNB#1/eNB#10. Otherwise, the storage medium and the processor may be provided as discrete components inside the mobile station UE and radio base stations eNB#1/eNB#10.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-099364 (filed on May 9, 2013) is incorporated by reference in the present specification.

### INDUSTRIAL APPLICABILITY

As described above, according to the present invention, it is possible to provide a mobile communication system which is capable of implementing “RRC diversity” in a handover procedure between cells under different radio base stations eNB, while considering conditions in a physical layer.

### EXPLANATION OF THE REFERENCE NUMERALS

eNB #1/eNB #10 radio base station
UE mobile station
11 resource allocation unit
12 transmission unit
13 reception unit

1. A mobile communication system comprising:
a first radio base station configured to manage a first cell; and
a second radio base station configured to manage a second cell, wherein the first radio base station and the second radio base station are configured to transmit a handover instruction signal to a mobile station connected to the first cell, in the first cell and the second cell, respectively, when a handover of the mobile station to the second cell is performed, and
the first radio base station and the second radio base station are configured to switch a subframe in a time-division manner between the first radio base station and the second radio base station, the subframe being a subframe to which a physical downlink control channel to transmit scheduling information concerning the handover instruction signal is allocatable.

2. A mobile communication system comprising:
a first radio base station configured to manage a first cell; and
a second radio base station configured to manage a second cell, wherein the first radio base station and the second radio base station are configured to transmit a handover instruction signal to a mobile station connected to the first cell, in the first cell and the second cell, respectively, when a handover of the mobile station to the second cell is performed,
the first radio base station is configured to transmit scheduling information concerning the handover instruction signal through a physical downlink control channel, and
the second radio base station is configured to transmit scheduling information concerning the handover instruction signal through an enhanced physical downlink control channel.

3. The mobile communication system according to claim 1, wherein the scheduling information is determined between the first radio base station and the second radio base station in coordinated multi-point transmission-reception establishment processing.

4. The mobile communication system according to claim 2, wherein the scheduling information is determined between the first radio base station and the second radio base station in coordinated multi-point transmission-reception establishment processing.
